(19) United States
(12) Patent Application Publication
(10) Pub. No.: US 2024/0416352 A1
(43) Pub. Date: Dec. 19, 2024

(54) Cryocooler Assemblies and Methods

(71) Applicant: Montana Instruments Corporation, Bozeman, MT (US)

(72) Inventors: Jamesen Motley, Bozeman, MT (US); William Baker, Broomfield, CO (US); Josh Doherty, Bozeman, MT (US); Joseph Evers, Bozeman, MT (US); Benjamin Hardesty, Flagstaff, AZ (US); Anjan Reijnders, Groton, MA (US)

(73) Assignee: Montana Instruments Corporation, Bozeman, MT (US)

(21) Appl. No.: 18/815,483

(22) Filed: Aug. 26, 2024

Related U.S. Application Data
(63) Continuation-in-part of application No. 16/597,655, filed on Oct. 9, 2019, now Pat. No. 12,071,998.
(60) Provisional application No. 62/743,482, filed on Oct. 9, 2018.

(51) Int. Cl. B01L 7/00

(52) U.S. Cl. CPC B01L 7/50; B01L 2200/0689; B01L 2300/1894; B01L 2400/0487

(57) ABSTRACT

Cryocooler assemblies are provided that can include: a first mass operatively engaged with a pumphouse configured to generate mechanical responses; a second mass operably engaged with the first mass; and an assembly between the first and second mass, the assembly configured to allow movement of the first mass in relation to the second mass.

Assemblies can include a coldhead operatively engaged with a chamber configured to retain cryofluid; and a first thermally conductive mass thermally engaged with the cryofluid.

Methods can include: generating a mechanical response about a first mass within a cryocooler assembly operatively engaged with a pumphouse; suspending the second mass in relation to the first mass of the assembly; and operatively engaging the second mass as a cold source for a sample chamber.

Additional methods can include operatively engaging at least cryofluid of a cryocooler with one or more thermally conductive masses.

### CROSS REFERENCE TO RELATED APPLICATION

This application is a continuation-in part of U.S. patent application Ser. No. 16/597,655 filed Oct. 9, 2019, which claims priority to and the benefit of U.S. Provisional Patent Application Ser. No. 62/743,482 filed Oct. 9, 2018, entitled “Cryocooler Assemblies and Methods”, the entirety of which is incorporated by reference herein. The entirety of U.S. patent application Ser. No. 16/597,680 filed Oct. 9, 2019, entitled “Cryocooler Assemblies and Methods” is hereby incorporated by reference herein.

### TECHNICAL FIELD

The present disclosure provides cryocooler assemblies and methods and in particular embodiments, the present disclosure provides cryocooler assemblies and methods that can be utilized in conjunction with variable temperature analytical instruments such as cryostats.

### BACKGROUND

Cryocoolers (a.k.a. “coldhead”) have been used to vary the temperature of samples during analysis well into the low Kelvin range of temperatures. During this variation of temperatures, vibrations can exist which can substantially impact the analysis of the sample. The present disclosure provides a cryocooler that, in at least some embodiments, reduces vibrations.

### SUMMARY

A cryocooler assembly is provided that can include: a first mass operatively engaged with a pumphouse, the operative engagement configured to generate mechanical responses; a second mass operably engaged with the first mass; and an assembly between the first and second mass, the assembly configured to allow movement of the first mass in relation to the second mass.

A method for isolating mechanical responses within a cryocooler assembly, is provided. The method can include: generating a mechanical response about a first mass within a cryocooler assembly operatively engaged with a pumphouse; suspending the second mass in relation to the first mass of the assembly; and operatively engaging the second mass as a cold source for a sample chamber.

A cryocooler assembly is provided that can include: a coldhead operatively engaged with a chamber configured to retain cryofluid; and a first thermally conductive mass thermally engaged with the cryofluid.

A method for providing one or more cold sources from a cryocooler is provided. The method can include operatively engaging at least the cryofluid of the cryocooler with one or more thermally conductive masses.

### BRIEF DESCRIPTION OF DRAWINGS

Embodiments of the disclosure are described below with reference to the following accompanying drawings.

FIG. 1 is a block diagram of an analytical instrument according to an embodiment of the disclosure.

FIG. 2 is a depiction of an assembly/instrument according to an embodiment of the disclosure.

FIG. 3 is a depiction of an assembly/instrument according to another embodiment of the disclosure.

FIG. 4 is a depiction of an assembly/instrument according to another embodiment of the disclosure.

FIG. 5 is a cryocooler according to an embodiment of the disclosure.

FIG. 6 is a cryocooler according to another embodiment of the disclosure.

FIG. 7 is a cryocooler according to another embodiment of the disclosure.

FIG. 8 is a cryocooler according to another embodiment of the disclosure.

FIG. 9 is a cryocooler according to another embodiment of the disclosure.

FIG. 10 is a cryocooler according to another embodiment of the disclosure.

FIG. 11 is a cryocooler according to another embodiment of the disclosure.

FIG. 12 is a cryocooler according to another embodiment of the disclosure.

FIG. 13 is a cryocooler according to another embodiment of the disclosure.

FIG. 14 is a cryocooler according to another embodiment of the disclosure.

### DESCRIPTION

This disclosure is submitted in furtherance of the constitutional purposes of the U.S. Patent Laws “to promote the progress of science and useful arts” (Article 1, Section 8).

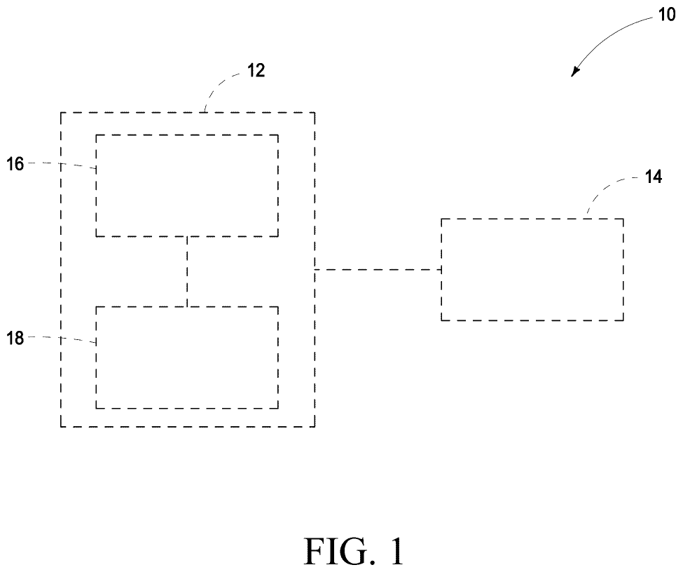

The assemblies and methods of the present disclosure will be described with reference to FIGS. 1-14. Referring first to FIG. 1, analytical instrument 10 is provided that includes a sample chamber 14 in operative communication with a cooling pod 12 that may include both a cooler 16 and a pumphouse 18. Pumphouse 18 can include a compressor and/or pumps configured to liquify gaseous cryofluid and/or transfer cryofluid (gas and/or liquid) to/from cooler 16. While cooling pod 12 is shown housing both cooler 16 and pumphouse 18, this is not necessary, but may be desirable as cooler 16 and pumphouse 18 may be housed separately but operatively coupled to one another and/or to sample chamber 14. In accordance with an example implementation, there can be separation (thermal, vacuum/pressure, and/or physical) of sample chamber 14 from cooler 16. Cooler 16 can include an operational coldhead for example. This is just one example of an instrument or assembly that can benefit from embodiments of this disclosure.

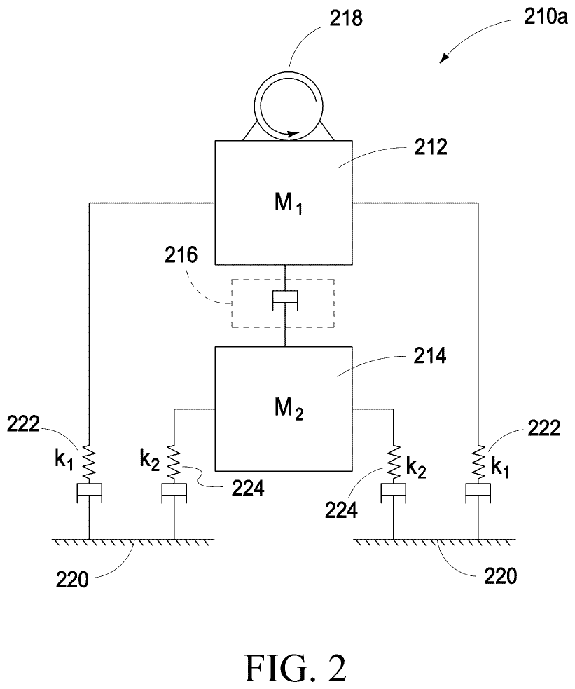

For example, and with reference to FIG. 2, instrument or assembly 210a can include masses 212 and 214 respectively. These masses can be operatively engaged via another assembly 216. In accordance with example implementations, both masses 212 and 214 may be in physical contact with a mounting surface 220 which may be the same or different surfaces. As a part of operating instrument or assembly 210a, a device 218 is engaged that generates mechanical responses, such as vibrations. Device 218 can be a prime mover such as a pump, motor, gas mover, etc. and/or may provide either or both of high or low frequency noise. Mass 212 can be engaged with surface 220 via spring and damper assembly 222. Spring and damper assemblies can include any assembly that includes: only a spring, only a damper, a spring and damper, but can functions to bias one mass in relation to another mass, one mass in relation to a surface, and/or both masses in relation to a surface. Spring and damper assemblies, pressure differences, and/or O-rings and/or assemblies can be utilized to suspend one mass in relation to another mass. The suspending of the masses can allow for motion between the masses in one, more, or all planes while still operatively engaging the masses. As one example, the coldhead motion in relation to the chamber of a cryocooler.

Mass 214 can be engaged with surface 220 via spring and damper assembly 224. The combination of the masses 212 and 214 with possibly different spring and damper assemblies 224 and 222 can provide a low pass filter connection to surface 220. Providing different combinations of masses and springs and dampers can provide for a purposeful mismatch in resonance frequency between masses 212 and 214 as they are engaged by assembly 216. Assembly 216 can include sliding complimentary components engaged by O-rings.

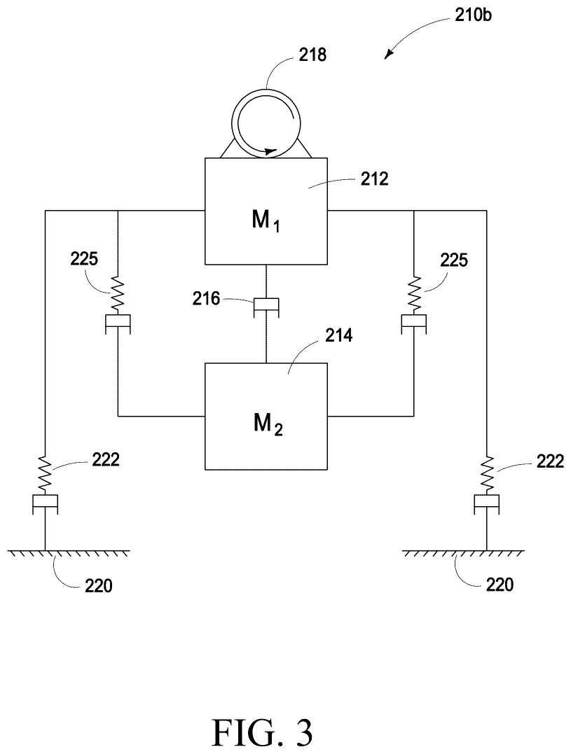

Referring next to FIG. 3, in accordance with an example implementation assembly 210b is depicted to demonstrate only one of masses 212 or 214 in physical contact with a mounting surface 220 with the other mass referenced to it. Mass 212 can be engaged with surface 220 via spring and damper assembly 222 and mass 214 can be engaged with mass 212 via spring and damper assembly 225.

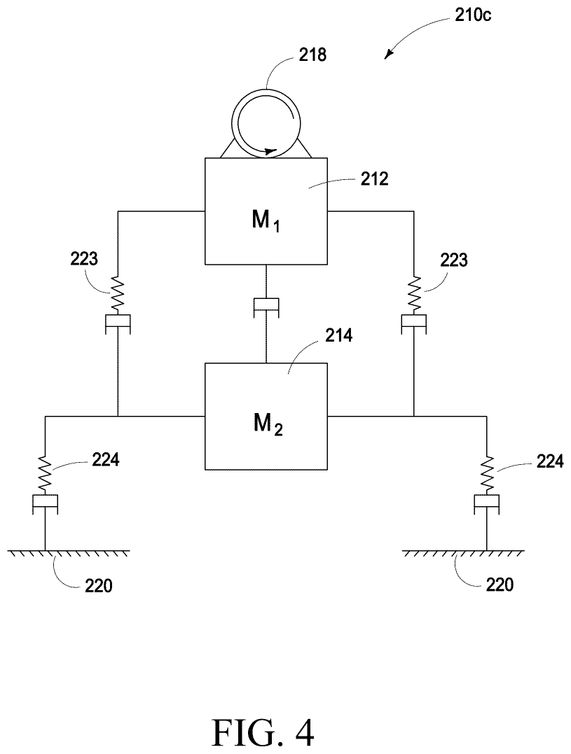

Referring next to FIG. 4, assembly 210c is shown that depicts a demonstration of yet another assembly configuration. Assembly 210c has mass 214 engaged with surface 220 via spring and damper assembly 224 and mass 212 can be engaged with mass 214 via spring and damper assembly 223.

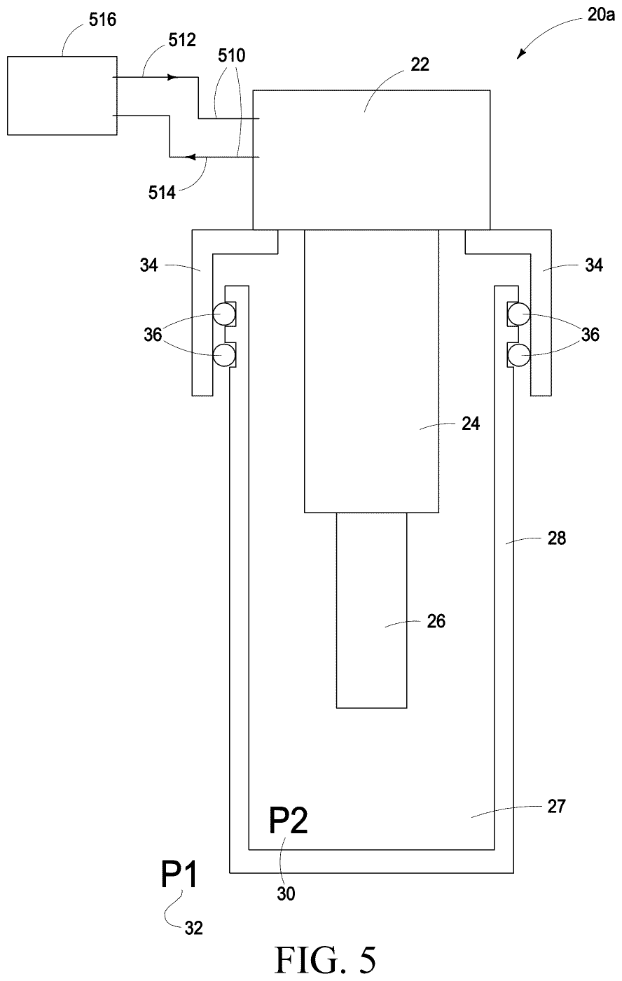

In accordance with example implementations cryocooler assemblies 20a-20e are depicted in FIGS. 5-9. Referring first to FIG. 5, a cryocooler assembly 20a is shown that includes a coldhead 22 that is arranged as a first stage 24 and second stage 26 coldhead device. Coldhead 22 can be operatively coupled to a compressor system providing coolant fluid such as but not limited to nitrogen and/or helium, for example, or alterations thereof. As shown in FIG. 5, pumphouse 516 (compressor and/or pumps) is operationally engaged with cryocooler assembly 20a. As shown this engagement is at coldhead 22, however other engagements are contemplated included engagement to within chamber 27 via coldhead support structure 34 or slidably engaged housing 28. Pumphouse 516 can be operably engaged with cryocooler assembly 20a via conduits 510. One of the conduits can be a supply 512 and the other a return 514. Supply 512 can be high-pressure and return 514 can be low-pressure. The use of these fluids with the compressor and the coldhead can yield low Kelvin temperatures at the second stage 26 of the coldhead. The coldhead can also be configured to provide a heat sink or cold source that can be linked to one or more masses to remove heat from or provide cooling to the one or more masses.

System 20a can include a chamber 27 that can be maintained at an interior pressure 30 that is substantially different than the exterior pressure 32. This pressure differential can be utilized to provide suspension force on the coldhead 22 within chamber 27 as desired. Accordingly, coldhead support structures 34 can be placed about housing 28 of chamber 27 to provide for a sliding engagement of structures 34 and housing 28, thereby suspending one mass in relation to another mass

Residing between housing 28 and coldhead support structures 34 can be a sealing structure 36 such as an O-ring or dual O-ring assembly. Sealing structure 36 can have improved functionality when compared to other implementations such as a rigid tube or bellows connection. For example, high resonance frequencies can be more effectively attenuated in all directions and modes (X-Y-Z translations, tip, tilt, and torsion between bodies 34 and 28) ultimately resulting in less mechanical energy transfer to body 28 and a lower resonance frequency of body 28.

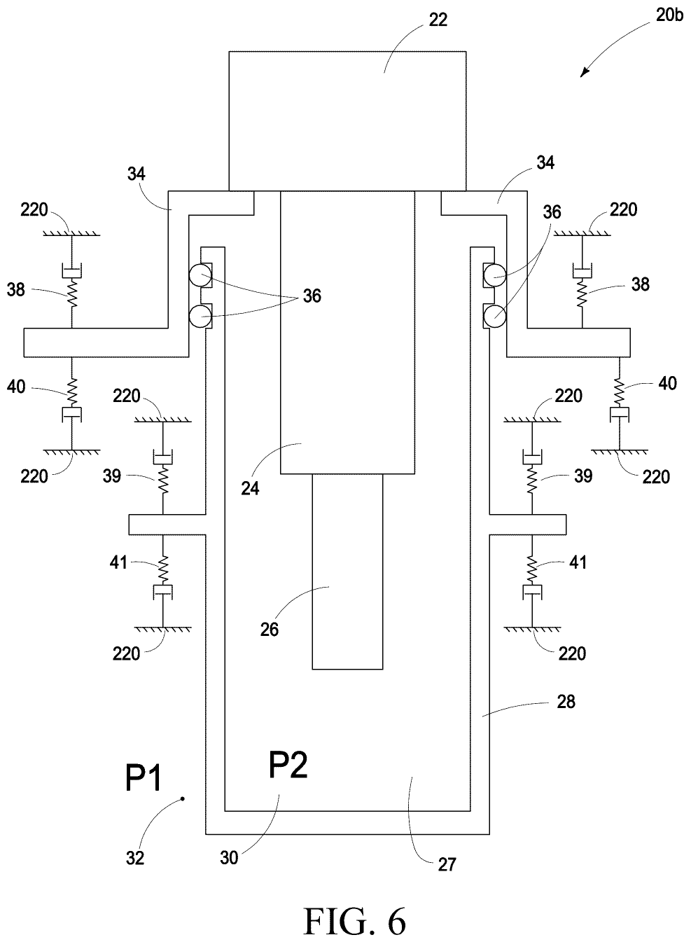

Referring to FIG. 6, assembly 20b is depicted that includes spring and damper assemblies 38-41 that are arranged according to an embodiment of the disclosure. In combination, sealing structure 36 and assemblies 38 and 40 can maintain the pressure differential between the interior and exterior volumes, but also provide a damping of vibrations generated about the coldhead thus limiting the vibrations extending to a sample that is supported by a mass which is coupled to the coldhead. Accordingly, support structure 34 can include upper spring and lower spring and damper assemblies 38 and 40, and coldhead 22 can be mechanically insulated from housing 28. These spring and damper assemblies 38 and 40, as well as other spring and damper assemblies can be tuned specifically to attenuate vibration transfer from the coldhead and coldhead support to the rest of instrument, including surface 220 to which the spring and dampers 38 and 40 are mounted. Also, the combined system of spring and damper assemblies 38 and 40 along with the coldhead mass can be purposefully de-tuned from the housing 28 mass and the spring and damper assemblies thus reducing the transmission of vibration from the coldhead to the housing 28 when mounted on common surface 220. For example, housing 28 can include upper spring and damper assembly 39 and lower spring and damper assembly 41 that can be tuned specifically, according to the mass and resonant frequency of the chamber, to reduce the vibrations of the chamber.

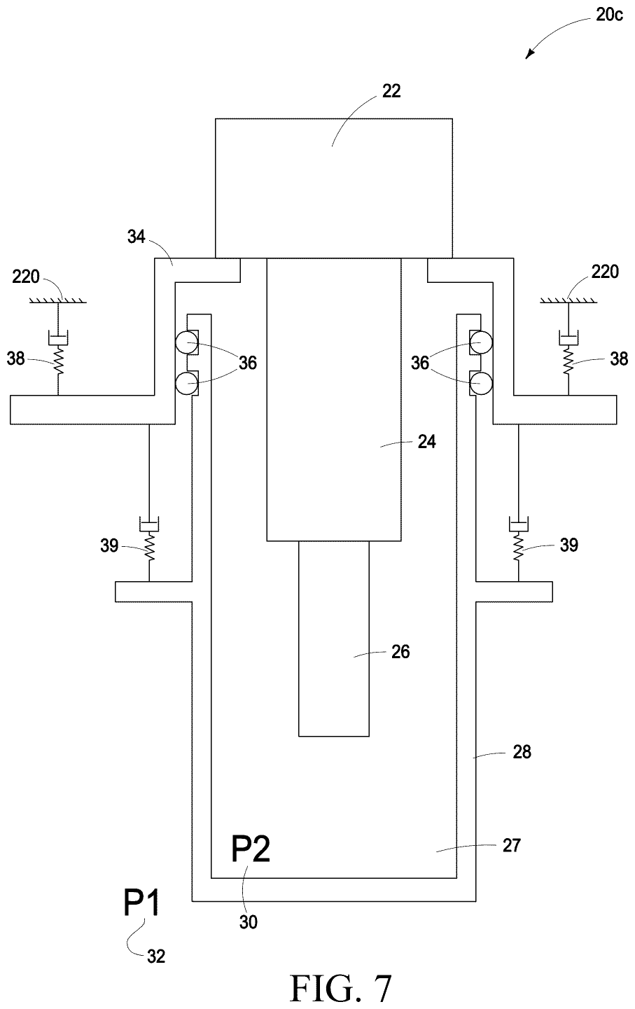

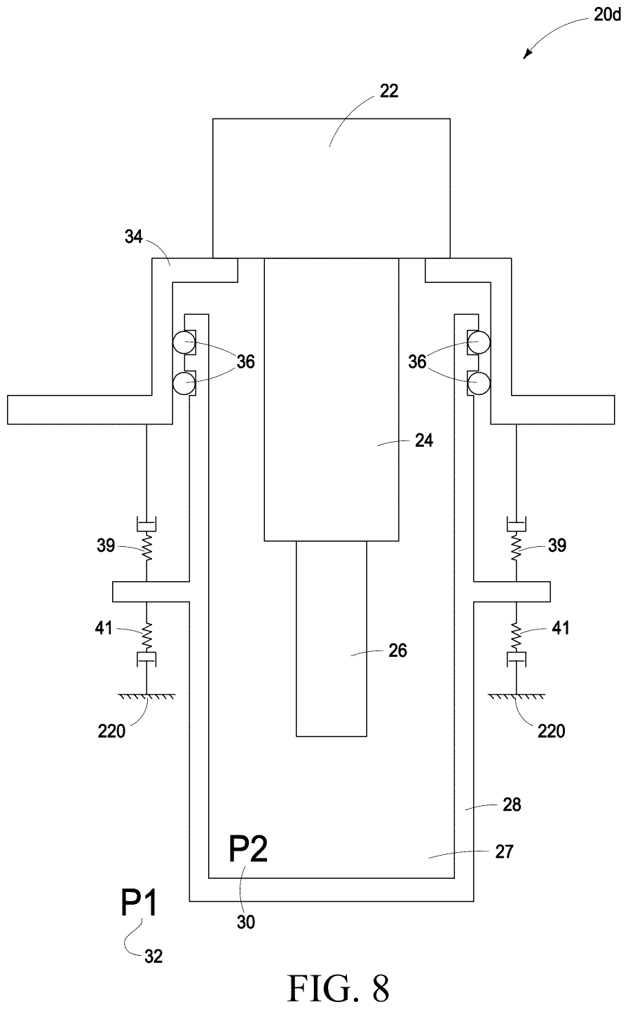

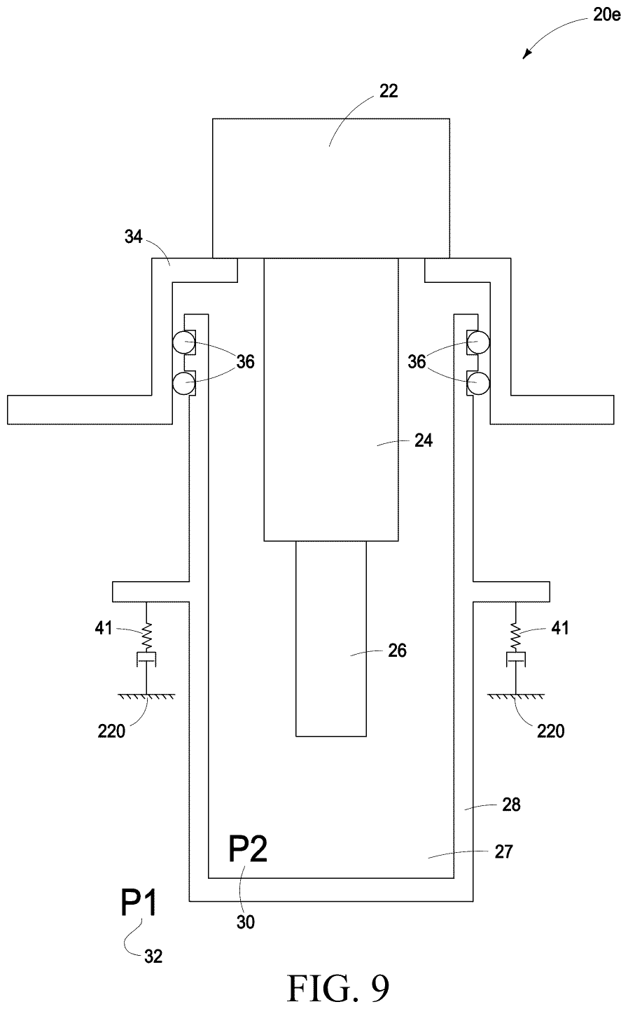

Referring to FIG. 7, assembly 20c depicts another configuration that provides for the spring and damper assemblies 39 mounted between the housing 28 and support structure 34 that is operatively engaged with surface 220 via spring and damper assemblies 38. Referring to FIG. 8, assembly 20d depicts another configuration having spring and damper assemblies 39 operatively engaged between support structure 34 and housing 28. Housing 28 may also have spring and damper assemblies 41 operatively engaged with surface 220. Referring to FIG. 9, assembly 20e depicts another configuration without a spring and damper assembly engagement to support structure 34. Assembly 20e can rely on the pressure differential between interior pressure 30 and exterior pressure 32 to support the mass of coldhead 22 and support structure 34. Accordingly, only housing 28 may be operably engaged with the surface 220 via spring and damper assemblies 41 in this specific embodiment.

In accordance with example implementations, coldhead 22 and supports 34 of FIGS. 5-9 can correspond to mass 212 of FIGS. 2-4, and housing 28 of FIGS. 5-9 can correspond to mass 214 of FIGS. 2-4. The arrangement of spring and damper assemblies can likewise correspond according to example implementations.

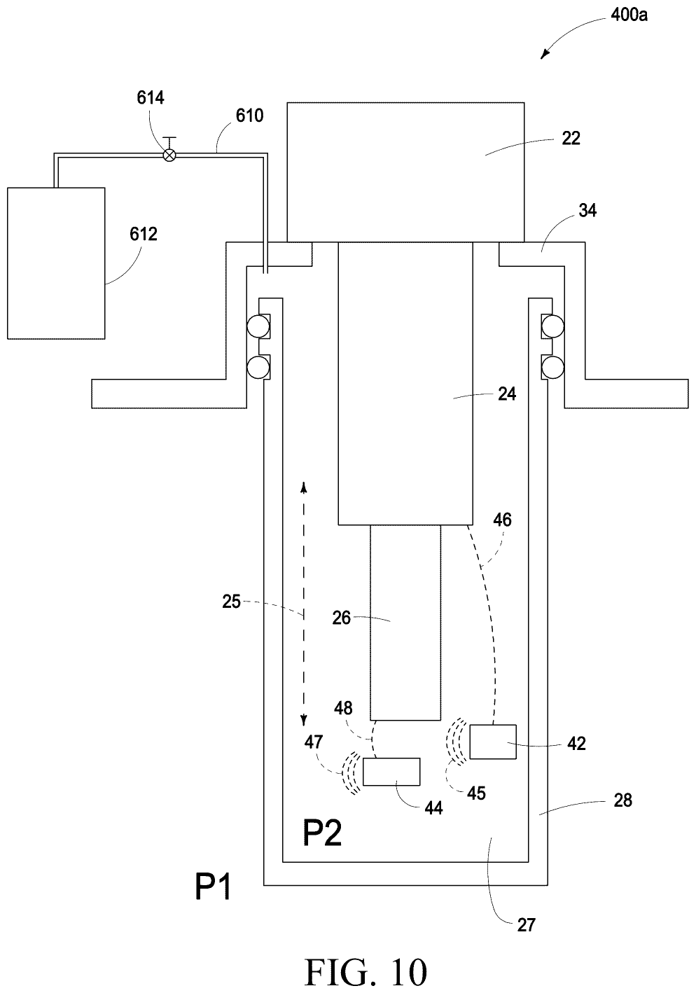

Referring next to FIGS. 10-12, cryocooler assemblies 400a-b are shown providing at least some of the contemplated cryocooler configurations. Each cryocooler can include a coldhead 22 having operable stages 24 and 26, for example. About the coldhead and stages can be a housing 28 that defines a chamber 27. At an upper portion of chamber 27 operatively engaged with structure 34 can be an inlet conduit 610 operationally connected to a supply 612, such as a tank of cryogenic fluid, for example helium or nitrogen. A pressure regulator 614, between supply 612 and chamber 27 can be configured to control the pressure of cryofluid within the chamber 27. In accordance with example operations, within chamber 27 a temperature gradient 25 can exist. For example, at the lower most portion of the chamber a liquid form of the cryofluid can exist and this may have the lowest most temperature of the cryofluid within the chamber. As the gradient extends away from the lower most portion of the chamber, the cryofluid may exist as a gas/liquid or as a gas and these temperatures are different, (higher) than the temperature of the liquid at the lower most portion of the chamber.

In accordance with example implementations, thermally conductive masses, such as masses 42, 44, 60, and/or 62 can be thermally engaged with the cryofluid within the chamber. This thermal engagement can be convective, conductive, and/or a combination of both. For example, masses 42, 44, 60, and/or 62 can be thermally engaged via convections 45, 47, 65, and/or 67 respectively. Accordingly, these masses have the temperature of the cryofluid with which they are thermally engaged. In accordance with other embodiments, these masses may be conductively engaged with both the cryofluid and the coldhead via respective thermal links 46, 48, 64, and/or 66. These thermally conductive links and/or masses may be constructed of thermally conductive materials such as copper.

In accordance with example implementations, the masses can be arranged in relation to the cryofluid to maintain the masses at a desirable temperature for use as a cold source for discrete portions of a cryoanalytical device.

Particular embodiments of the cryocooler assemblies can include at least one thermal link extending from a coldhead 22 within chamber 27. Referring to FIG. 10, assembly 400a is shown that includes separate thermal links 46 and 48 extending from corresponding first and second stages 24 and 26 of coldhead 22 within chamber 27. While two links are depicted in this configuration, a single link from the coldhead is contemplated. As shown, specific portions of the coldhead can be in thermal connection with specific masses 42 and 44 via respective thermal links 46 and 48. In this particular embodiment, the spring and damper assemblies can be tuned to minimize vibrations transfer from the coldhead to mass 42 and mass 44. Again, this thermal communication can include, but is not limited to: flexible conductive lines; and/or conduction and/or convection through the cryofluid within chamber 27. The thermal links can allow for large relative motion between the masses 42 and 44 and the respective thermal connection points thus leading to an additional mechanical isolation. Masses 42 and 44 can also be suspended from coldhead stages 24 and 26 through a spring and damper assembly that is not depicted here, or mounted to housing 28 through a spring and damper assembly that is not depicted, but also contemplated.

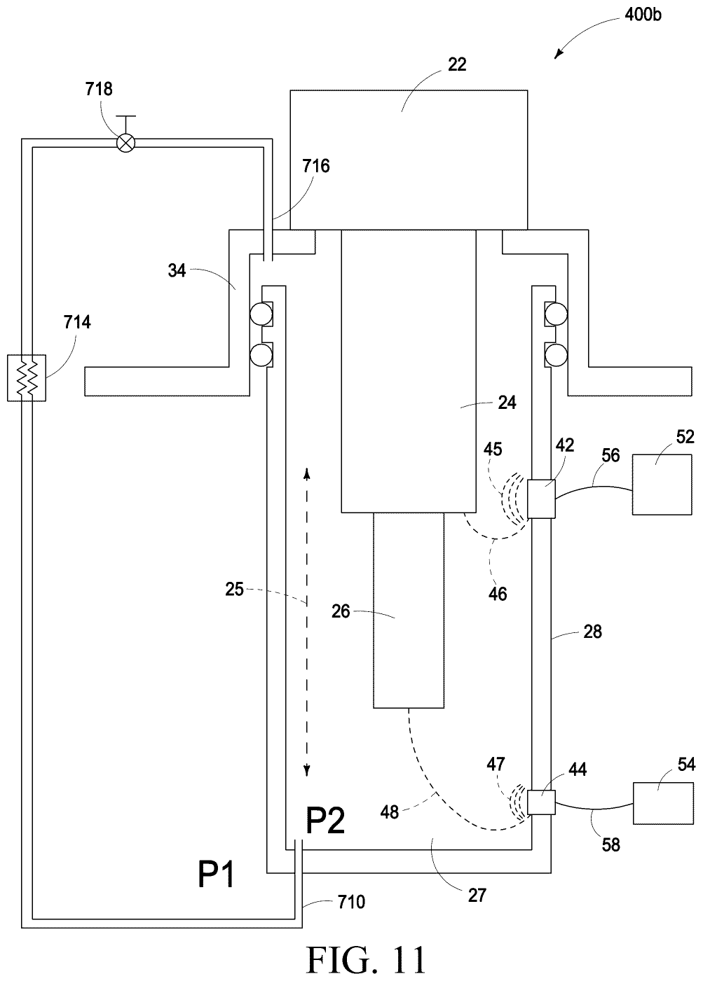

Referring next to FIG. 11, assembly 400b is depicted that includes portions 42 and 44 of chamber housing 28. These portions can be thermally conductive while other portions of chamber housing 28 are insulative. In accordance with example implementations, thermal gradient 25 may exist in the cryofluid contained within the chamber 27 and the thermal masses 42 and 44 may be positioned at different heights, for example near the second stage 26 and/or first stage 24 of the coldhead for example, to utilize different temperatures along the temperature gradient of the fluid, and the associated cooling powers. Accordingly, thermal links 45 and 47 can provide cold source links as a liquid or gas thermal link between the contents of the chamber the proximate mass. As further depicted in FIG. 11, assembly 400b may include a cryofluid outlet 710 at a lower portion of chamber 27 and operationally engaged with housing 28. Cryofluid within chamber 27 can exit chamber 27 via outlet 710 and enter chamber 27 through inlet 716, in a closed loop manner. As shown, inlet 716 can be operationally engaged with structure 34. The cryofluid can travel from exit 710 through a heat exchanger 714. Heat exchanger 714 can be in thermal communication with a sample device and this thermal communication can be a cold source for the sample device. After travelling through the heat exchanger, the cryofluid flow can be controlled with a regulator 718 before returning to chamber 27 via conduit 716.

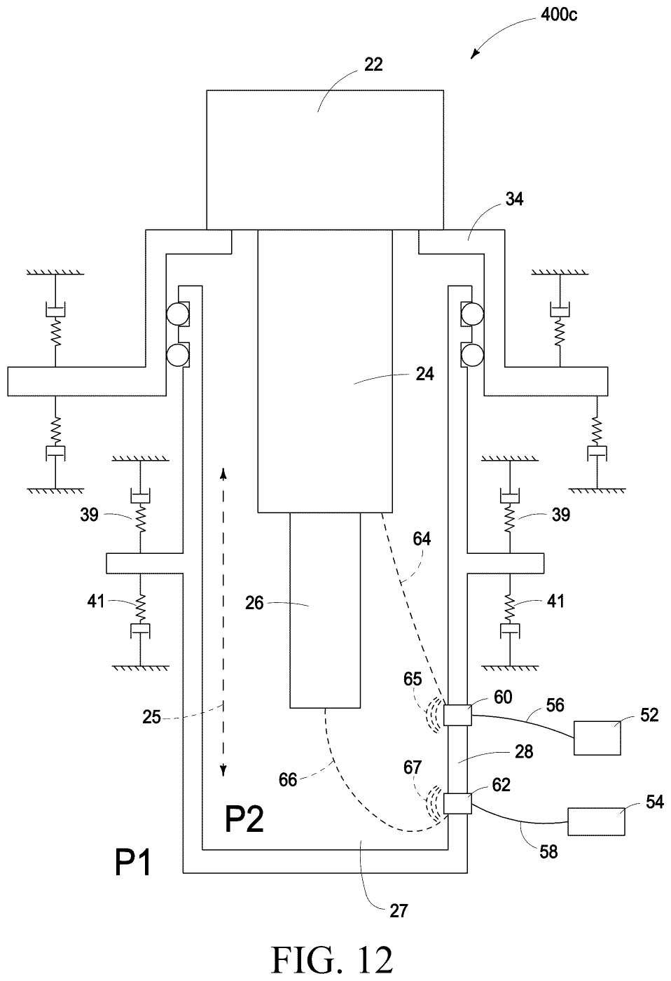

Referring next to FIG. 12, assembly 400c is depicted in accordance with another implementation, masses 52 and 54 are in thermal communication with thermally conductive portions 60 and 62 respectively via thermal links 56 and 58. These contacts are in thermal connection, via flexible conductive lines and/or conduction and/or convection through the cryofluid, with the coldhead via additional links 64 and 66 and/or convections 65 and 67. As shown, spring and damper assemblies 39 and 41 can be tuned to minimize vibrations transfer from the coldhead to mass 52 and mass 54. In accordance with example implementations, masses 52 and/or 54 can define portions of a cryoanalytical device utilizing and/or associated with the cryocooler assembly. For example, the portions of the cryoanalytical device can include a radiation shield or a sample mounting surface or fixture.

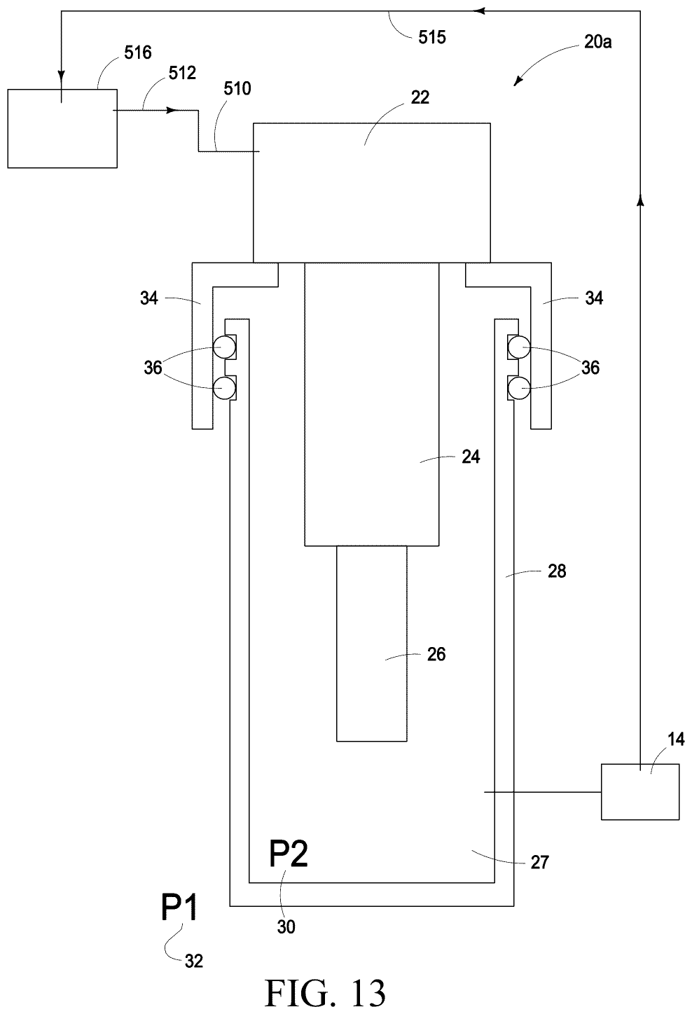

Referring next to FIG. 13, in this embodiment, return 515 to pumphouse 516 initiates at sample chamber 14. Accordingly, cryofluid is provided from chamber 27 to sample chamber 14.

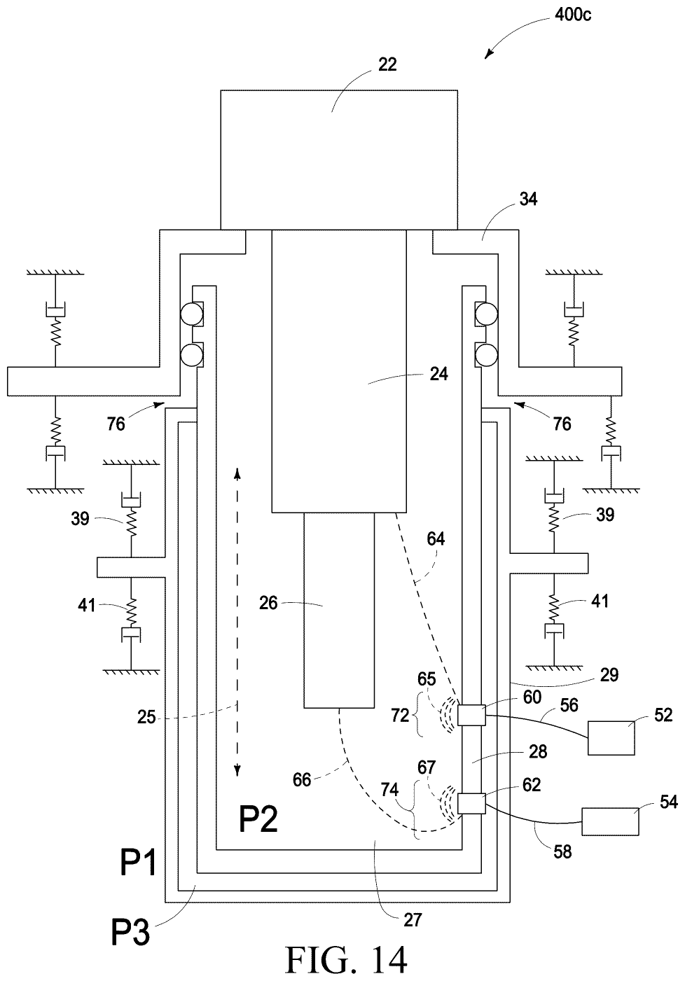

Referring next to FIG. 14, another cryocooler embodiment is provided that includes another housing (e.g., jacket) 29 about housing 28. As shown, jacket 29 can extend about housing 28 and together define pressurized chamber P3. In example implementations, P2 can be equal to, less than, or greater than P3, while P1 is greater than P2 and P3. While jacket 29 is shown extending about the bottom and lateral sides of housing 28, it may terminate at point 76 in order to allow housing 28 to slidably engage support structure 34. Additionally, in the shown embodiment jacket 29 can be coupled with damper assemblies. Additionally, jacket 29 can be integrated with housing 28 without damper assemblies, for example as a modification of the cryocooler of FIG. 11. Additionally, while shown encompassing lateral sides and the bottom of housing 28, jacket 29 can be specific to conductive masses (60 and 62, for example). In these embodiments, about portions 72 and 74 respectively, can be discrete jackets about the exterior of housing 28 to at least encompass the mass and provide a vacuum chamber P3 about same.

In compliance with the statute, embodiments of the invention have been described in language more or less specific as to structural and methodical features. It is to be understood, however, that the entire invention is not limited to the specific features and/or embodiments shown and/or described, since the disclosed embodiments comprise forms of putting the invention into effect.

1. A cryocooler assembly comprising:
a first mass operatively engaged with a pumphouse, the operative engagement configured to generate mechanical responses;
a second mass operably engaged with the first mass; and
an assembly between the first and second mass, the assembly configured to allow movement of the first mass in relation to the second mass.

2. The cryocooler assembly of claim 1 wherein the pumphouse comprises one or both of a pump or a compressor.

3. The cryocooler assembly of claim 2 wherein the first mass is mechanically coupled to the compressor.

4. The cryocooler assembly of claim 1 wherein the first mass includes a coldhead of the cryocooler.

5. The cryocooler assembly of claim 4 wherein the second mass is configured as a chamber of the cryocooler.

6. The cryocooler assembly of claim 1 wherein the assembly between the first and the second masses is configured to provide a sliding engagement between the masses.

7. The cryocooler assembly of claim 1 wherein the assembly comprises an O-ring.

8. The cryocooler assembly of claim 1 wherein the assembly comprises a pair of radial seal O-rings.

9. The cryocooler assembly of claim 1 further comprising at least one spring and damper assembly, the spring and damper assembly operatively extending from the second mass.

10. The cryocooler assembly of claim 9 wherein the spring and damper assembly operatively engages the other mass or a surface.

11. A method for isolating mechanical responses within a cryocooler assembly, the method comprising:
generating a mechanical response about a first mass within a cryocooler assembly operatively engaged with a pumphouse;
suspending the second mass in relation to the first mass of the assembly; and
operatively engaging the second mass as a cold source for a sample chamber.

12. The method of claim 11 wherein the generating the mechanical response comprises operating a prime mover.

13. The method of claim 11 wherein the first mass is a coldhead and the generating the mechanical response comprises operatively engaging the pumphouse with the coldhead.

14. The method of claim 13 wherein the second mass is a chamber configured to retain cryofluid generated with the coldhead.

15. The method of claim 14 further comprising providing a pressurized space within the chamber and between the two masses that is different than ambient pressure.

16. The method of claim 15 wherein the pressurized space is greater than the ambient pressure and suspends the first mass in relation to the second mass.

17. The method of claim 15 wherein the operatively engaging comprises sealing the space between the two masses.

18. The method of claim 17 wherein the sealing comprises retaining the pressure within the space while allowing the masses to move in relation to one another.

19. The method of claim 11 wherein the suspending further comprises engaging one or more spring and damper assemblies about either or both of the masses.

20. The method of claim 19 wherein at least one of the spring and damper assemblies is operably engaged with a support surface.

21. A cryocooler assembly comprising:
a coldhead operatively engaged with a chamber configured to retain cryofluid; and
a first thermally conductive mass thermally engaged with the cryofluid.

22. The cryocooler assembly of claim 21 further comprising a thermal link between the coldhead and the first thermally conductive mass.

23. The cryocooler assembly of claim 21 further comprising a second thermally conductive mass thermally engaged with the cryofluid.

24. The cryocooler assembly of claim 23 further comprising a thermal link between the coldhead and the second thermally conductive mass.

25. The cryocooler assembly of claim 23 wherein the first thermally conductive mass is arranged about the chamber in relation to cryofluid having a first temperature, and the second thermally conductive mass is arranged about the chamber in relation to a cryofluid having a second temperature that is different from the first temperature.

26. The cryocooler assembly of claim 23 wherein the coldhead defines multiple stages, and wherein the assembly further comprises first and second thermal links each individually extending from one stage of the coldhead to the first thermally conductive mass, and from another stage of the coldhead to the second thermally conductive mass.

27. The cryocooler assembly of claim 21 wherein the first thermally conductive mass defines at least one portion of the chamber.

28. The cryocooler assembly of claim 27 further comprising a second thermally conductive mass thermally engaged with the cryofluid and defining at least another portion of the chamber.

29. The cryocooler assembly of claim 28 wherein the coldhead defines multiple stages, and wherein the assembly further comprises first and second thermal links each individually extending from one stage of the coldhead to the first thermally conductive mass, and from another stage of the coldhead to the second thermally conductive mass.

30. The cryocooler assembly of claim 21 further comprising a second thermal link extending from the first mass to a second mass.

31. The cryocooler assembly of claim 30 wherein the second mass is an element of a cryocooler analytical device.

32. The cryocooler assembly of claim 21 further comprising:
a second thermally conductive mass thermally engaged with the cryofluid; and
one or more thermal links, each thermal link extending from the first and/or second thermally conductive masses.

33. The cryocooler assembly of claim 32 wherein the additional thermal links extend to discrete portions of a cryocooler analytical device.

34. The cryocooler assembly of claim 32 wherein the first thermally conductive mass defines at least a first portion of the chamber and the second thermally conductive mass defines at least a second portion of the chamber.

35. The cryocooler assembly of claim 34 further comprising a third thermal link extending from the first thermally conductive mass to a third mass; and a fourth thermal link extending from the second thermally conductive mass to a fourth mass.

36. The cryocooler assembly of claim 35 wherein either or both of the third and fourth masses are discrete elements of a cryocooler analytical device.

37. A method for providing one or more cold sources from a cryocooler, the method comprising operatively engaging at least the cryofluid of the cryocooler with one or more thermally conductive masses.

38. The method of claim 37 further comprising using one or more thermal links to provide the one or more cold sources to the one or more thermally conductive masses.

39. The method of claim 37 wherein at least one of the one or more thermally conductive masses defines at least a portion of the cryocooler chamber.

40. The method of claim 37 wherein at least one of the one or more thermally conductive masses is an element of a cryocooler analytical device.

41. The method of claim 40 further comprising providing multiple thermal links from multiple portions of the cryocooler to provide multiple cold sources to multiple elements of a cryocooler device.
